(19) United States
(12) Patent Application Publication
(10) Pub. No.: US 2003/0085495 A1
(43) Pub. Date: May 8, 2003

(54) Material for controlling plasticity, wet strength, and other working characteristics of water-based ceramics

(76) Inventor: Jonathan Singer, Seattle, WA (US)

Correspondence Address: Laura A. Majerus, 59 Club Dr., San Carlos, CA, 94070, US

(21) Appl. No.: 10/145,931

(22) Filed: May 10, 2002

Related U.S. Application Data
(63) Continuation of application No. 09/618,140, filed on Jul. 17, 2000, now abandoned.
Application No. 09/618,140 is a division of application No. 09/026,394, filed on Feb. 19, 1998, now abandoned.

(51) Int. Cl. C08J 3/00

(52) U.S. Cl. 264/669; 524/27; 264/670

(57) ABSTRACT

A method of making a water-based ceramic that contains carrageenan and various average-molecular-weight preparations of poly(ethylene oxide). Various other materials can be added to yield mixtures appropriate for specialized applications.

### FIELD OF THE INVENTION

This application relates to water-based ceramics and methods of preparing water-based ceramics.

### BACKGROUND OF THE INVENTION

Plasticity, wet strength, and other working characteristics of water-based ceramic compositions are customarily controlled by addition of mineral additives. These may include (but are not limited to) clays and claylike minerals such as bentonite and macaloid, ball clay, and so on. These additives are necessary in the case of conventional porcelain formulations, and desirable in the case of stoneware formulations.

These mineral additives typically contain elements such as iron and titanium. These can be undesirable, particularly in porcelain compositions, where whiteness and translucency are desirable characteristics. Both iron and titanium contribute to coloration and, in some cases, opacity of the fired ceramic objects that are made of water-based ceramic compositions. Moreover, mineral additives may compromise the strength and durability of the final fired product.

While it is desirable to make water-based ceramic compositions that withstand heat, it is difficult to make water-based ceramic compositions with extremely low temperature coefficient of expansion and little or no free crystalline silica, in part because mineral additives introduced to control plasticity tend to increase the coefficient of expansion of the final product and may encourage the presence of free crystalline silica. Crystalline silica occurs in several forms, which undergo abrupt dimensional change as the material passes through certain specific temperatures. Thus, the presence of crystalline silica created during temperature changes makes the ceramic composition crack, break, or lose structural integrity when it is heated abruptly, as on a stovetop. Such cracking or breaking is generally due to thermal shock.

The following two documents provide examples of conventional ceramics and/or techniques and are herein incorporated by reference. U.S. Pat. No. 4,755,494 to Ruben entitled “Use of Pectin or Pectin-like Material in Water-Based Ceramics” and U.S. Pat. No. 4,912,069 to Ruben entitled “Use of Pectin or Pectin-like Material in Water-Based Ceramics.”

### SUMMARY OF THE INVENTION

Preferred embodiments of the present invention use organic materials as additives to water-based ceramics. The described embodiments use a combination of natural and synthetic polymer materials as additives in water-based ceramic compositions (so-called “pottery bodies”). The natural polymers include at least carrageenan and may optionally include Xanthan gum (and/or other vegetable gum) as stiffeners. The synthetic polymers include various average-molecular-weight preparations of poly(ethylene oxide).

The invention specifically depends upon the interaction between poly(ethylene oxide) and carrageenan (for example, lambda carrageenan (which is a form of carrageenan that does not gel in solution), iota Carrageenan or a combination of iota and lambda Carrageenan). Although poly(ethylene oxide) is sometimes used in ceramics to increase “green strength” (strength of the dried but unfired product), that is not its purpose here; nor is it suitable to this method without the presence of carrageenan. Although carrageenan is occasionally used as a suspension agent for glazes, it is not conventionally used in pottery bodies.

Advantages of the invention will be set forth in part in the description that follows and in part will be obvious from the description or may be learned by practice of the invention. The objects and advantages of the invention will be realized and attained by means of the elements and combinations particularly pointed out in the appended claims and equivalents.

### DESCRIPTION OF THE PREFERRED EMBODIMENTS

Reference will now be made in detail to several preferred embodiments of the invention.

Preferred embodiments of the present invention use organic materials as additives to water-based ceramics. These organic materials are removed from ceramic compositions by normal processing, and thus do not have any noticeable effect on whiteness, translucency, or strength and durability of the final fired product.

Appropriate Concentration Ranges of the Additives

Water-based ceramic compositions in accordance with the present invention can be made using ingredients in varying proportions as described below.

Carrageenan: from about 0.1% of total dry mineral weight to about 2.5% of total dry mineral weight. Dry mineral weight (is defined as the total weight of dry minerals in the mix (e.g., kaolin, dry stoneware formulation, earthenware formulations, feldspar, silica, petalite, etc.). Carrageenan generally contains a large number of sulfate groups. This is an important difference between Carrageenan and other materials and makes carrageenan effective for pottery bodies.

Poly(ethylene oxide): from about 1/16 of carrageenan weight (when poly(ethylene oxide) having molecular weight 4 million is used) to about ⅖ of carrageenan weight (when poly(ethylene oxide) having molecular weight 600,000 is used). In general, poly(ethylene oxide) having lower molecular weight can be used with the higher end of the range.

In the particular case of porcelain compositions that are intended for wheel-throwing by hand, optimal concentration of carrageenan is about 1.0% to 1.25% of the weight of the dry minerals, at a carrageenan:poly(ethylene oxide) ratio of about 10:1, with poly(ethylene oxide) of molecular weight in the range of 0.1 million to 8 million. Especially good results for wheel throwing can be obtained by using poly(ethylene oxide) of molecular weight in the range of 0.6 to 4 million. Alternately, a mixture of poly(ethylene oxides) having at least two different molecular weights in this range can be used, as described below.

The type of carrageenan used can be, for example, lambda carrageenan available from FMC Corporation, Pharmaceutical Division. As a further example, artists' carrageenan can also be used. As yet other examples, pure lambda carrageenan, pure iota carrageenan, or a combination of iota and lambda carrageenan can be used. The primary differences between iota and lambda Carrageenan are the number and position of the ester sulfate groups on repeating galactose units. Higher levels of ester sulfate lower the solubility temperature of the Carrageenan. A lower solubility temperature produces lower strength gels and contributes to gel inhibition.

The following three documents describe commercial varieties of carrageenan and are herein incorporated by reference. “Marine Colloids Carrageenan, General Technology for Pharmaceutical and Other Applications,” available from FMC Corp., copyright 1993; “Marine Colloids Carrageenan Data Sheet for Viscarin GP-209 Carrageenan,” available from FMC Corp., copyright 1996; and “Marine Colloids Carrageenan Data Sheet for Gelcarin GP-359 Carrageenan,” available from FMC Corp., copyright 1996.

Optionally, Xanthan gum (or other appropriate vegetable gums, such as guar gum, etc.) can be added to increase stiffness and wet strength. Optimal concentration range for Xanthan gum is 0.01% to 0.25% by weight, per weight of dry minerals.

Optionally, isopropanol can be added, partly as a preservative and partly to produce thixotropy when that property is desirable. Isopropanol, additionally, assists in drying of the composition and in the separation of finished pieces from the supports (“batts”) on which they were thrown. Preferable concentration range for isopropanol is 0.0% to 4% (or more), by weight, per weight of dry minerals; e.g., up to approximately 100 g (grams) of 99% isopropanol for 2.5 kg dry minerals. In much larger amounts, isopropanol interferes with wet strength. For example, when the porcelain compositions are intended for wheel-throwing by hand and for molding, optimal concentration is in the range of 0.5% to 0.75%. Amounts of isopropanol are given here by volume; the density of isopropanol is approximately 0.786 g/cm³. In the examples given herein, isopropanol is an optional ingredient and may be included in amounts up to those given.

This invention is further illustrated by the following examples, which are presented for the purpose of example only and are not to be taken as limiting the scope of the invention.

### EXAMPLE 1

To 1 kg of kaolin (e.g., TOPAZ kaolin from ECC International, Roswell, Ga.), add 600 cc of water (this can be distilled or not distilled). This water should preferably be warm or hot. Stir thoroughly and allow to slake for at least 15 minutes or, optionally, longer.

Dry ingredients: To 1 kg of feldspar (e.g., G-200 feldspar from Feldspar Corporation) and 0.5 kg of silica (e.g., SilCoSil), add 20 g carrageenan (e.g., available from Daniel Smith Artists' Supplies, Seattle Wash.), 2 g poly(ethylene oxide) of average molecular weight 1 million (e.g., PolyOx N-12K, Union Carbide Corporation) and 0.5 g Xanthan gum (e.g., Bob's Red Mill). Stir thoroughly.

Add 30 cc of 70% isopropanol (rubbing alcohol) to the slaked kaolin. Stir thoroughly. Add dry ingredients. Stir thoroughly. (At this stage, the material is not yet fully aggregated or mature, and appears loose, crumbly, and moist.) Allow to mature for at least 15 minutes.

Knead thoroughly by hand, or pass through an appropriate machine (“de-airing pug mill”) to achieve the same result, which is the development of the correct working consistency and the removal of excess air. After a desirable further period of maturation lasting about 30 minutes, the composition may be thrown by hand on a potter's wheel or molded to shape.

### EXAMPLE 2

To 1 kg of TOPAZ kaolin, add 600 cc (preferably warm or hot) water. Stir thoroughly and reserve.

Dry ingredients: To 1 kg of G-200 feldspar and 500 g silica, add 25 g of carrageenan and 2.5 g poly(ethylene oxide), average molecular weight 1 million. Mix thoroughly.

After allowing the kaolin to slake for at least 15 minutes or, preferably, longer, stir the dry ingredients into the kaolin slurry, mixing thoroughly. Knead the result until it is smooth in consistency, or pass it through a pug mill, as in the preceding example.

The use of increased amounts of additives (in this example, 1% carrageenan and 0.1% poly(ethylene oxide)) produces a slightly stiffer ceramic composition, which is suitable for the usual purposes, e.g., molding and wheel-throwing.

### EXAMPLE 3

To 1 kg of dry stoneware formulation (in this example, UWL 412, Clay Art Center, Tacoma, Wash.) add 10 g carrageenan (1%) and 1.25 g poly(ethylene oxide) of average molecular weight 600,000 (e.g., PolyOx WSR-205, Union Carbide Corp.). Mix thoroughly.

Add 275 g warm (or hot) water. Mix thoroughly. Preferably, allow to mature for 15 minutes or longer. Knead by hand or pug in a mechanical mill, as in preceding examples. Preferably, allow to mature again for 15 minutes or longer.

This method results in a stoneware composition with increased wet strength, a desirable feature for wheel throwing, sculpture, and other applications. If a springier or more rubbery composition is desired, poly(ethylene oxide) of higher average molecular weight should be used.

### EXAMPLE 4

As example 1, but: 32.5 g carrageenan, 3.25 g poly(ethylene oxide) at 1 million average molecular weight, 0.5 g Xanthan gum, 22.5 cc of 99% isopropanol, 630 g water.

The composition provided by example 4 is firm and slightly stiff in comparison with most commercial throwing porcelains. It might optionally benefit from the addition of a small amount of water (e.g., 10-50 g), or from the omission of the Xanthan gum, which acts as a stiffener.

Approximately three hours after throwing, a representative piece made from the pottery body of example 4 had dried sufficiently to be handled, and could be removed from its batt without damaging or seriously deforming it. (This was, however, in summer. In winter, when the air is cooler and wetter, it can take a week or more for a representative thrown piece to detach easily from the batt.)

### EXAMPLE 5

To 1 kg kaolin (e.g., TOPAZ kaolin), add 600 g (preferably warm or hot) water. Stir thoroughly, and allow to slake for at least 15 minutes. (Slaking may optionally continue for 48 hours or longer.)

Dry ingredients: To 1 kg G-200 feldspar and 500 g silica, add 37.5 g bentonite (e.g., food grade, HerbPharm, Inc., Williams Oreg.); 20 g carrageenan, 2.5 g poly(ethylene oxide), average molecular weight 1 million; and, optionally, 0.5 g Xanthan gum. Mix thoroughly.

Add 15 cc 99% isopropanol to the slaked kaolin. Stir thoroughly. Add dry ingredients and stir to form wetted lumps. Preferably, allow to mature for at least 15 minutes in this state. Knead by hand or pug in a mechanical mill as in preceding examples.

This example demonstrates compatibility of this method with traditional (mineral-additive) methods, as does example 3, above (bentonite, in this case).

This example results in a pottery body that is optimized for wheel-throwing by hand, but can, alternatively, be molded to shape.

### EXAMPLE 6

A porcelain body having 8 parts TOPAZ kaolin (or other kaolin that is suitably pure, containing very little iron or titanium, such as GROLLEG kaolin from ECC, International), 8 parts petalite (a lithium-containing aluminosilicate mineral), and 3 parts silica, when fired to Orton cone 11 (pyrometric cones are manufactured in the USA by the Orton foundation; cone 11 corresponds, roughly speaking, to a temperature in the range of 1305 to 1324° Celsius), is substantially flameproof, and is suitable for stovetop or oven use.

To 800 g TOPAZ kaolin, add 480 g water. Stir thoroughly and set aside for at least 15 minutes, or preferably up to 24 hours (or, optionally, longer) to slake. (It is acceptable to stir constantly for the minimal period or optionally longer.) Here the use of a pure kaolin, such as TOPAZ kaolin or GROLLEG kaolin is important.

Add 9.5 cc 99% isopropanol to the slaked kaolin and stir thoroughly.

Dry ingredients: To 800 g petalite and 300 g silica, add 19 g lambda carrageenan (e.g., Viscarin GP-209, FMC Corp. Pharmaceutical Division) and 1.9 g poly(ethylene oxide) of average molecular weight (per manufacturer's specification) 1 million (e.g., PolyOx N-12K, Union Carbide Corp.). Mix thoroughly.

Add dry ingredients to slaked kaolin, and mix thoroughly. (At this stage, the material is moist, partially aggregated, crumbly.) Knead or pug as in previous examples, after a maturation period (preferable) of at least 15 minutes.

Example 6 uses a different material as its flux (i.e., petalite, which itself contributes to decreased thermal expansion) and is suitable for throwing and/or pressing. Its composition also makes it flameproof. Slight modifications may be necessary to produce material suitable for molding, or material that matures under different firing conditions.

So-called “laboratory porcelain,” “electrical porcelain,” and “electrical insulator porcelain”, as well as so-called “high-alumina” ceramics, likewise display extremely low thermal expansion without abrupt changes of dimension at particular temperatures; but these materials are not typically suitable for wheel-throwing, nor do they as a rule mature appropriately under conditions obtainable in pottery kilns.

Optimizing for Wheel-throwing

### EXAMPLE 7

To 1 kg TOPAZ kaolin, add 625 g water. Stir thoroughly and set aside for at least 15 minutes, or preferably up to 24 hours (or, optionally, longer) to slake. (It is acceptable to stir constantly for the minimal period or, optionally, longer.) Preferably, stir thoroughly at the end of the slaking period to ensure uniformity.

Add 20 g 99% isopropanol to the slaked kaolin and stir thoroughly.

Dry ingredients: To 1 kg G-200 feldspar and 500 g silica, add 30 g lambda carrageenan (e.g., Viscarin GP-209, FMC Corp. Pharmaceutical Division), 1.5 g poly(ethylene oxide) of average molecular 1 million (e.g., PolyOx N-12K, Union Carbide Corp.), and 1.0 g poly(ethylene oxide) of average molecular weight 4 million (e.g., PolyOx WSR-301). Mix thoroughly.

Add the dry ingredients to the slaked kaolin, and mix thoroughly. Preferably, allow to mature for at least 15 minutes, and knead or pug as in previous examples.

This results in a porcelain body that matures at or near cone 11 and is optimized for wheel-throwing by hand. It is slightly springy or rubbery in comparison with mineral-additive-based throwable porcelains.

This example uses two poly(ethylene) oxides of different molecular weights. As described below, other variations may use more than two different molecular weights of poly(ethylene) oxide. The use of some high-molecular-weight polymer (in this example, 40% of total poly(ethylene oxide) content) provides increased plasticity and wet strength, at the expense of some change in the texture and consistency of the material. The use of 30 g of lambda carrageenan partially compensates for this change, and may increase wet strength as well.

The increased amount of water (625 g, 25% of dry mineral weight) compensates for the increased quantity of carrageenan. With 600 g water (24% of dry mineral weight), this mixture is stiffer than optimal for hand kneading and for throwing on the potter's wheel. It may, however, be appropriate for press-molding.

### EXAMPLE 8

To 2 kg kaolin (e.g., TOPAZ kaolin), add 1300 g water (this is 26% of the dry mineral weight). Stir and allow to slake as in previous examples.

Add optionally, up to 40 cc of 99% isopropanol to the slaked kaolin and stir thoroughly.

Dry ingredients: To 2 kg feldspar (e.g., G-200) and 1 kg silica, add 55 g lambda carrageenan (e.g., Viscarin GP-209, FMC Corp. Pharmaceutical Division), 7 g poly(ethylene oxide) of average molecular weight 600,000 (e.g., PolyOx), 2 g poly(ethylene oxide) of average molecular weight 1 million (e.g., PolyOx), and 1 g poly(ethylene oxide) with average molecular weight 4 million.

Add the dry ingredients to the slaked kaolin, and mix thoroughly. Preferably, allow to mature for at least 15 minutes, and knead or pug as in previous examples.

This example demonstrates the principle of balancing several molecular weights of poly(ethylene oxide) to control plasticity and strength.

### EXAMPLE 9

To 200 g kaolin (e.g., from the Georgia, Feldspar Corporation), add 130 g water (this is 26% of the dry mineral weight). Stir and allow to slake as in previous examples.

No isopropanol is added in this example, although it can optionally be added.

Dry ingredients: To 200 g feldspar (e.g., Custer, Pacer Corp, Custer, S.Dak.) and 100 g silica, add 5.5 g lambda carrageenan (e.g., Viscarin GP-209, FMC Corp. Pharmaceutical Division), 0.7 g poly(ethylene oxide) of average molecular weight 600,000 (e.g., PolyOx), 0.2 g poly(ethylene oxide) of average molecular weight 1 million (e.g., PolyOx), and 0.1 g poly(ethylene oxide) with average molecular weight 4 million.

Add the dry ingredients to the slaked kaolin, and mix thoroughly. Preferably, allow to mature for at least 15 minutes, and knead or pug as in previous examples.

This example also demonstrates the principle of balancing several molecular weights of poly(ethylene oxide) to control plasticity and strength and the use of kaolin other than TOPAZ. This example, like the other examples given herein, produces a throwable porcelain.

### EXAMPLE 10

To 200 g kaolin (e.g., EPK, from the Feldspar Corp.), add 135 g water (this is 27% of the dry mineral weight). Stir and allow to slake as in previous examples.

Add optionally, up to 5 cc of 99% isopropanol to the slaked kaolin and stir thoroughly.

Dry ingredients: To 200 g feldspar (e.g., Custer) and 100 g silica, add 8 g lambda carrageenan (e.g., Viscarin GP-209, FMC Corp. Pharmaceutical Division), 0.6 g poly(ethylene oxide) of average molecular weight 600,000 (e.g., PolyOx), 0.4 g poly(ethylene oxide) of average molecular weight 1 million (e.g., PolyOx).

Add the dry ingredients to the slaked kaolin, and mix thoroughly. Preferably, allow to mature for at least 15 minutes, and knead or pug as in previous examples.

This kaolin benefits from a further maturation period preferably exceeding one hour, followed by a desirable, but not required, second kneading. This example illustrates the use of a kaolin with characteristics that are very different from those of TOPAZ. Note the increase in the amount of carrageenan, as well as the alteration in the balance of poly(ethylene oxide). The mixture is throwable.

### EXAMPLE 11

To 200 g kaolin (e.g., TOPAZ kaolin), add 130 g water. Stir and allow to slake as in previous examples.

No isopropanol is added in this example, although it should be possible.

Dry ingredients: To 200 g feldspar (e.g., G-200) and 100 g silica (e.g., Sil-Co-Sil, US Silica Corp.), add 5 g lambda carrageenan, 0.5 g of iota carrageenan (e.g., Gelcarin type GP-379NF, from FMC Corp.), 0.6 g poly(ethylene oxide) of average molecular weight 600,000 (e.g., PolyOx), 0.4 g poly(ethylene oxide) of average molecular weight 1 million (e.g., PolyOx).

Add the dry ingredients to the slaked kaolin, and mix thoroughly. Preferably, allow to mature for at least 15 minutes, and knead or pug as in previous examples.

This example illustrates the use of iota carrageenan. It produces a slightly stiffer consistency than would the same composition with 5.5 g of lambda carrageenan, lacking the iota carrageenan. Iota carrageenan tends to produce a decrease of plasticity, and it is probably not suitable as the sole source of carrageenan in this example. Iota carrageenan is useful in the range of 0% through 25% inclusive present in a batch.

### EXAMPLE 12

To 400 g kaolin (e.g., TOPAZ), add 260 g water. Stir and allow to slake as in previous examples.

Add optionally, up to 6 cc of 99% isopropanol to the slaked kaolin and stir thoroughly.

Dry ingredients: To 400 g feldspar (e.g., G-200) and 200 g silica, add 10 g lambda carrageenan (e.g., Viscarin GP-209, FMC Corp. Pharmaceutical Division), 1 g iota carrageenan, 0.9 g poly(ethylene oxide) of average molecular weight 600,000 (e.g., PolyOx), 0.3 g poly(ethylene oxide) of average molecular weight 1 million (e.g., PolyOx).

Add the dry ingredients to the slaked kaolin, and mix thoroughly. Preferably, allow to mature for at least 15 minutes, and knead or pug as in previous examples.

This example yields a ceramic material that is smooth and non-rubbery.

Summary

Over the range of batch sizes described herein, scaling is entirely nominal. There is every reason to believe that smaller and larger batch sizes should behave as these batches do.

For example, the examples above may use various dry minerals other than those described without departing from the spirit and scope of the invention. In addition, various sources of and types of carrageenan and poly(ethylene) oxide other than those described can be employed without departing from the spirit and scope of the invention. Moreover, other sources for and types of additives such as Xanthan gum and isopropanol can be used without departing from the spirit and scope of the invention. Any appropriate known mixing technique can be used.

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A ceramic composition, comprising:
dry minerals;
carrageenan; and
a preparation of poly(ethylene oxide).

2. The ceramic composition of claim 1, further comprising Xanthan gum.

3. The ceramic composition of claim 1, wherein the carrageenan is lambda carrageenan.

4. The ceramic composition of claim 1, wherein the carrageenan is iota carrageenan.

5. The ceramic composition of claim 1, further comprising isopropanol.

6. The ceramic composition of claim 5, wherein the concentration range of the isopropanol is greater than 0.0% and less than or equal to 4%, by weight, per weight of the dry minerals

7. The ceramic composition of claim 5, wherein the concentration range of the isopropanol is 0.5% to 0.75%, by weight, per weight of the dry minerals.

8. The ceramic composition of claim 1, wherein:
the carrageenan is of a range from about 0.1% of the total weight of the dry minerals to about 2.5% of the total weight of the dry minerals; and
the poly(ethylene oxide) is from about 1/16 of the weight of the carrageenan to about ¼ of the weight of the carrageenan.

9. The ceramic composition of claim 1, wherein the poly(ethylene oxide) has a molecular weight in the range of 0.1 million to 8 million.

10. The ceramic composition of claim 1, wherein:
the carrageenan is of a range from about 0.1% of the total dry mineral weight to about 2.5% of the total dry mineral weight; and
the poly(ethylene oxide) is about 1/10 of the carrageenan weight.

11. The ceramic composition of claim 1, wherein:
the carrageenan is of a range from about 1.0% of the total dry mineral weight to about 1.25% of the total dry mineral weight; and
the poly(ethylene oxide) is about 1/10 of the carrageenan weight.

12. The ceramic composition of claim 1, wherein the poly(ethylene oxide) is a mixture of poly(ethylene) oxide having at least two different molecular weights.

13. A ceramic composition, comprising:
from about 0.1% of total dry mineral weight of the composition to about 2.5% of total the total dry mineral weight of carrageenan; and
from about 1/16 of carrageenan weight to about ¼ of carrageenan weight of Poly(ethylene oxide).

14. The ceramic composition of claim 13, wherein the poly(ethylene oxide) has a molecular weight in the range of 0.1 million to 8 million.

15. The ceramic composition of claim 13, further comprising Xanthan gum.

16. The ceramic composition of claim 13, wherein the carrageenan is lambda carrageenan.

17. The ceramic composition of claim 13, wherein the carrageenan is iota carrageenan.

18. The ceramic composition of claim 13, further comprising isopropanol.

19. The ceramic composition of claim 18, wherein the concentration range of the isopropanol is greater than 0.0% and less than or equal to 4%, by weight, per the total dry mineral weight.

20. The ceramic composition of claim 18, wherein the concentration range of the isopropanol is in the range of 0.5% to 0.75%.

21. The ceramic composition of claim 13, wherein the poly(ethylene oxide) is a mixture of poly(ethylene) oxide having at least two different molecular weights.

22. A ceramic composition, comprising:
from about 1.0% of the total dry mineral weight of the composition to about 1.25% of the total dry mineral weight of carrageenan; and
about 1/10 of carrageenan weight of Poly(ethylene oxide).

23. The ceramic composition of claim 22, further comprising Xanthan gum.

24. The ceramic composition of claim 22, wherein the carrageenan is lambda carrageenan.

25. The ceramic composition of claim 22, wherein the carrageenan is iota carrageenan.

26. The ceramic composition of claim 22, further comprising isopropanol.

27. The ceramic composition of claim 26, wherein the concentration range of the isopropanol is greater than 0.0% and less than or equal to 4%, by weight, per the total dry mineral weight.

28. The ceramic composition of claim 26, wherein the concentration range of the isopropanol is in the range of 0.5% to 0.75%.

29. The ceramic composition of claim 22, wherein the poly(ethylene oxide) has a molecular weight in the range of 0.1 million to 8 million.

30. The ceramic composition of claim 22, wherein the poly(ethylene oxide) is a mixture of poly(ethylene) oxide having at least two different molecular weights.
